(19) United States
(12) Patent Application Publication
(10) Pub. No.: US 2006/0101734 A1
(43) Pub. Date: May 18, 2006

(54) Window or door

(75) Inventors: Christian Fischer, Halle (DE); Elmar Knepper, Bogen (DE)

Correspondence Address: PITNEY HARDIN LLP, 7 TIMES SQUARE, NEW YORK, NY, 10036-7311, US

(73) Assignee: THYSSEN POLYMER GmbH

(21) Appl. No.: 11/240,347

(22) Filed: Sep. 29, 2005

(30) Foreign Application Priority Data
Oct. 21, 2004 (DE) 10 2004 051 407.0

(51) Int. Cl. E06B 3/26

(52) U.S. Cl. 52/202

(57) ABSTRACT

The invention relates to a window, door, facade element or conservatory whose insulating glass pane (3) is bonded to the casement frame (1) on the base (1a) of which an all-round sealing lip is provided, projecting to the front side of the insulating glass pane and which may have a predetermined fold with which the holding space (1b) for the adhesive (1c) is limited.

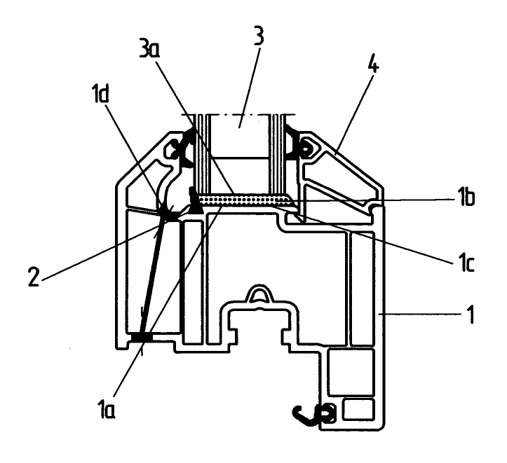

Window or door with an insulating glass pane which is in a casement frame profile and which is connected to this by means of an adhesive layer running round the front side.

Insulating glass panes bonded with the casement frame of a window are actually known. In these cases, bonding is effected in the glass rebate. The so-called graded insulating glass panes used for this must be opaquely coloured in complicated processing stages by means of an enamelling process. Cost-effective production is thus not possible.

A different procedure is shown for example in AT 410 463 B, with a rigid limiting link for the adhesive mass made of the frame material and located vertically in the window rebate, projecting to about the centre of the gap between the front side of the insulating glass pane and the casement rebate. Here, there is no connection between this link and the front side of the insulating glass pane. Such a casement window, however, has various disadvantages.

The limiting link leads to a sharply restricted tolerance field for the insulating glass pane. Insulating glass panes are supplied with differing tolerances, not only in the diagonal but also in the width and length dimensions. This means that when the glass pane is inserted, this may lead to contact between the pane and the glass rebate, which can lead to damage. Furthermore, with this type of casement window only full-area all-round bonding can be carried out, since otherwise, through the seal of the wing overlap, any water that may enter would be blown through this limiting link into the glass rebate as so-called leak water, collect in the region of the glass rebate and would run into the glass strip rebate, from where it could run unhindered into the interior of the window frame. In all cases this leads to a malfunction of the window. In the event that the glass pane should not be bonded but should be constructed conventionally using blocks, for example in special element construction, then special custom-made block bridges are required, since the limiting link does not allow the use of normal block bridges without special recesses for this link.

This is where the invention takes effect. The task of the invention is to create a window or the like with bonding of the insulating glass pane to the glass rebate of the frame profile, reliably avoiding the disadvantages of known windows of this type, with a seal preventing dampness or water entering, limiting the rise of the adhesive to be inserted and allowing the insulating glass pane to be block-mounted conventionally, without any additional effort, using commercially available block bridges.

In accordance with the invention, this problem is solved with a window, door, facade element, conservatory or the like in accordance with the characteristic features of claim 1 in conjunction with the features of the heading.

The advantages achieved with the invention, besides the avoidance of the disadvantages of the latest state of technology, are that the front side of the insulating glass pane and the adhesive inserted in the holding gap are protected from penetrating water and damp through the all-round sealing lip mounted in the glass rebate, and also that in the event of excessive pressure caused by excessive quantities of adhesive, the sealing lip limits the rise of the adhesive in the gap between the front side of the insulating glass pane and the base of the glass rebate through defined folding, thus allowing the adhesive to drain off into the drainage area of the frame profile. This also means that no leak water caused by driving rain or unfavourable pressure conditions can enter the area of the glass strip rebate or the interior of the frame; a further advantage is that on account of the sealing effect of the sealing lip, simpler adhesives sensitive to water can also be used. Yet another advantage of the invention is that any tolerances in the insulating glass panes are compensated for by the continuous equal space between the front side of the insulating glass pane and the rebate. The good sealing effect of the sealing lip, through which no damp can penetrate as far as the adhesive mass, ensures that even after years of use no disintegration of the adhesive mass can occur and the use of the window or the like is assured.

The invention is explained in greater detail in the following on the basis of an embodiment shown in the illustration.

The illustration shows a frame profile 1 with a glass rebate 1a and a holding space 1b for an adhesive mass 1c and a drain channel 1d for any damp that may enter. At the left-hand end of the glass rebate 1a, as shown in the illustration, there is a sealing lip 2, which can have different degrees of Shore hardness and which has a predetermined fold which, in the event of excessive pressure caused by excessive amounts of inserted adhesive mass, folds away and clears the way to the drainage area of drain channel 1d. In particular, however, the sealing lip 2 serves to prevent any water or damp from penetrating through the glass seal to the adhesive mass 1c. This is particularly important in the event of driving rain, strong wind and unfavourable pressure conditions. The sealing lip 2 projects from the left-hand edge of the glass rebate la at least to the front side 3a of the insulating glass pane 3. This also eliminates the production tolerances of the insulating glass pane 3, since the distance between the glass rebate and the front side of the insulating glass pane 3 is about 3 mm. A glass strip is designated 4.

The solution proposed in the invention can be used advantageously with casement windows, also with fixed windows, as well as doors and conservatories and also facade elements, irrespective of the materials the casements or frames are made of; even frameless designs are possible.

1. Window, door, facade element or conservatory with an insulating glass pane which is in a casement frame profile and which is connected to this by means of an adhesive layer running round the front side, wherein an all-round sealing lip (2) is provided in the base (1a) of the profile rebate of the casement frame profile (1), said sealing lip projecting at least to the front side (3a) of the insulting glass pane (3) and limiting the holding space (1b) between the base (1a) and the insulating glass pane (3) and said sealing lip (2) being coextruded or post-extruded and being laterally connected to the base (1a) of the frame profile (1), with the sealing lip (2) being inserted in an all-round groove in the base (1a) of the frame profile (1).

2. Window or the like in accordance with claim 1, wherein the sealing lip (2) has different degrees of Shore hardness.

3. Window or the like in accordance with claim 1, wherein the sealing lip (2) has a predetermined fold.

4. Window or the like in accordance with claim 1, wherein the frame profile (1) is made of rigid PVC.

5. (canceled)

6. (canceled)
